(19) United States
(12) Patent Application Publication
(10) Pub. No.: US 2025/0234074 A1
(43) Pub. Date: Jul. 17, 2025

(54) GENERATION OF MEDIA SEGMENTS FROM LARGER MEDIA CONTENT FOR MEDIA CONTENT NAVIGATION

(71) Applicant: Roku, Inc., San Jose, CA (US)

(72) Inventors: Kapil Kumar, London (GB); Srimaruti Manoj Nimmagadda, Saratoga, CA (US); Nitish Aggarwal, Sunnyvale, CA (US); Abhishek Majumdar, Santa Clara, CA (US)

(73) Assignee: Roku, Inc., San Jose, CA (US)

(21) Appl. No.: 18/597,099

(22) Filed: Mar. 6, 2024

Related U.S. Application Data
(60) Provisional application No. 63/620,402, filed on Jan. 12, 2024.

(51) Int. Cl. H04N 21/845; G06F 40/30

(52) U.S. Cl. CPC H04N 21/8456; G06F 40/30

(57) ABSTRACT

A method is described and includes obtaining a list of utterances comprising captions from an item of content; computing sentence transformer embeddings for each of the utterances; dividing the utterances into sentences and extracting a sentence embedding for each sentence; computing a semantic similarity between adjacent sentences; and merging the adjacent sentences into a block comprising a segment if the semantic similarity between the adjacent sentences is greater than a predetermined threshold.

### RELATED APPLICATIONS

This non-provisional application claims priority to and/or receives benefit from provisional application having Ser. No. 63/620,402, titled “GENERATION OF MEDIA SEGMENTS FROM LARGER MEDIA CONTENT FOR MEDIA CONTENT NAVIGATION”, and filed on Jan. 12, 2024. The provisional application is hereby incorporated by reference in its entirety.

### TECHNICAL FIELD

This disclosure relates generally to multimedia systems, and more specifically, to techniques for generating media segments from larger media content for use in media content navigation and other applications.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a block diagram of an example multimedia environment according to some embodiments of the disclosure.

FIG. 2 illustrates a block diagram of an example media device according to some embodiments of the disclosure.

FIG. 3 illustrates properties of a media segment according to some embodiments of the disclosure.

FIG. 4 illustrates a high-level block diagram of a system for generating media segments from larger media content according to some embodiments of the disclosure.

FIG. 5 illustrates a flow diagram of example operations performed for generating media segments from larger media content according to some embodiments of the disclosure.

FIG. 6 illustrates a block diagram of an exemplary computing device, according to some embodiments of the disclosure.

### DETAILED DESCRIPTION

### Overview

Content providers and streaming platforms providing such content may manage and allow users to access and view thousands to millions or more content items. Content items may include media content, such as audio content, video content, image content, extended reality (XR) content (which may include one or more of augmented reality (AR) content, virtual reality (VR) content, and/or mixed reality (MR) content), gaming content, etc. Once a user selects content for viewing via a multimedia system, it would be beneficial to provide mechanisms or systems that enable the user to navigate intelligently through the selected content, in addition to simply fast-forwarding and rewinding through the content in a conventional manner. Such intelligent navigation may include navigating a user directly to a particular point in the selected content corresponding to a subject identified by the user (e.g., by the user's providing a search string comprising a word or words associated with the subject). The particular point may include, for example, the location(s) in the content where the particular word/words are mentioned, the location(s) in the content corresponding to the beginning of a sentence in which the word or words are mentioned, and the location(s) in the content corresponding to the beginning of a topic (e.g., a collection of sentences in which the word or words are mentioned) corresponding to the subject.

For example, assuming a user is viewing content comprising Italian cooking instructions and would like to view the portion of the content related specifically to making pasta, the user may input a search string such as “how to make pasta” and the intelligent navigation system may navigate the user directly to next topic/sentence/word in the content. Additionally and/or alternatively, the user may be provided with a list of locations or points (e.g., topics/sentences/words) in the content corresponding to the search string from which to select. In particular embodiments, each point may be accompanied in the list by a thumbnail corresponding to the point that may assist the user in selecting the particular point to which they would like to navigate.

In accordance with particular embodiments described herein, a content segmentation system for supporting intelligent content navigation and other applications may be implemented by taking as input subtitles associated with content and dividing the content into topics based on the subtitles, thereby enabling creation of short clips, or “shorts.” The system may further take video data comprising the content as input and divide the video data into video shots, which video shots are aligned using the subtitles to provide a smooth ending to the shorts.

In particular embodiments, sentence transformer embeddings are computed from subtitles of a particular item of content for every utterance Uᵢ. Utterances {U₁, . . . . U_{M}} are divided into blocks (i.e., sentences) {Sᵢ, . . . . S_{K}} and the MPNet embedding Sᵢ is computed for each block. Next, the cosine similarity sim between adjacent blocks Sᵢ and Sᵢ₊₁ is computed, where simᵢ represents the semantic similarity between two blocks separated at utterance Uᵢ. If the cosine similarity is greater than a given threshold, the two sentences Sᵢ and Sᵢ₊₁ are merged. This process is repeated for all of the sentences and the output is the blocks of sentences. Open source pyscenedetect may be used to detect split video in shots. The start and end times of each block of sentences are checked and if the end time of a block is close to the end time of the video shot, the end time of the shot is updated to align with the end time of the block.

### Example Multimedia Environment

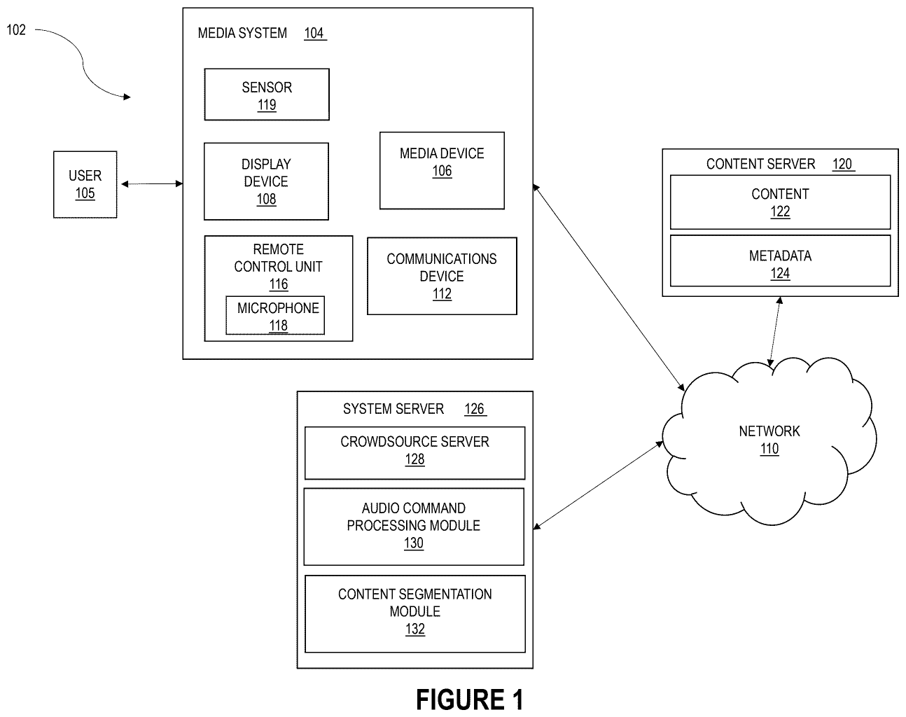

FIG. 1 illustrates a block diagram of an example multimedia environment 102 according to some embodiments described herein. In a non-limiting example, multimedia environment 102 may be directed to streaming media; however, embodiments described herein may be applicable to any type of media instead of or in addition to streaming media, as well as any type of mechanism, means, protocol, method, and/or process for distributing media.

Multimedia environment 102 may include one or more media systems, such as media system 104. Media system 104 may represent a family room, a kitchen, a backyard, a home theater, a school classroom, a library, a car, a boat, a bus, a plane, a stadium, a movie theater, an auditorium, a bar, a restaurant, an extended reality (XR) space, and/or any other location or space where it may be desirable to receive, interact with, and/or play streaming content. Users, such as user 105, may interact with media system 104 as described herein to select, view, interact with, and/or otherwise consume content.

Each media system 104 may include one or more media devices, such as media device 106, each of which may be coupled to one or more display devices, such as display device 108 (which may be implemented as an A/V device). It will be noted that terms such as “coupled,” “connected,” “attached,” “linked,” “combined,” as well as similar terms, may refer to physical, electrical, magnetic, local and/or other types of connections, unless otherwise specified herein.

Media device 106 may include a streaming media device, DVD or BLU-RAY device, audio/video playback device, cable box, an XR device (which may include one or more of a VR device, an AR device, and an MR device), and/or digital video recording device, for example. Display device 108 may include a monitor, a television, a computer, a smart phone, a tablet, a wearable (e.g., a watch, glasses, goggles and/or an XR headset), an appliance, an Internet-of-Things (IoT) device, and/or a projector, for example. In some embodiments, media device 106 may be a part of, integrated with, operatively coupled to, and/or connected to one or more respective display devices, such as display device 108.

Media device 106 may be configured to communicate with network 110 via a communications device 112. Communications device 112 may include, for example, a cable modem or satellite TV transceiver. Media device 106 may communicate with the communications device 112 over a link that may include wireless (e.g., Wi-Fi) and/or wired connections.

In various embodiments, network 110 may include, without limitation, wired and/or wireless intranet, extranet Internet, cellular, Bluetooth, infrared, and/or any other short range, long range, local, regional, and/or global communications mechanism, means, approach, protocol, and/or network, as well as any combinations thereof.

Media system 104 may include a remote control device 116. Remote control device may include and/or be incorporated into any component, part, apparatus, and/or method for controlling media device 106 and/or display device 108, such as a remote control, a tablet, a laptop computer, a smartphone, a wearable, on-screen controls, integrated control buttons, audio controls, XR equipment, and/or any combination thereof, for example, In one embodiment, remote control device 116 wirelessly communicates with media device 106 and/or display device 108 using any wireless communications protocol. Remote control device 116 may include a microphone 118. Media system 104 may also include one or more sensors, such as sensor 119, which may be deployed for tracking movement of user 105, such as in connection with XR applications. In particular embodiments, sensor 119 may include one or more of a gyroscope, a motion sensor, a camera, an IMU, and a biometric sensor, for example. Sensor 119 may also include one or more sensing devices for sensing biometric characteristics associated with sympathetic arousal, including one or more of heart rate variability (HRV), electrodermal activity (EDA), pupil opening, and/or eye movement. In some embodiments, sensors, such as sensor 119, may be incorporated into a device to be worn by users, such as a headset or vest. In particular embodiments, sensor 119 may comprise any sort of XR device.

Multimedia environment 102 may include a plurality of content servers 120, which may also be referred to as content providers or sources. Although only one content server 120 is shown in FIG. 1, multimedia environment 102 may include any number of content servers 120, each of which may be configured to communicate with network 110. Content servers 120 may be managed by one or more content providers. Each content server 120 may store content 122 and metadata 124. Content 122 may include media content, such as audio content, video content, image content, XR (e.g., VR, AR, and/or MR) content, gaming application content, advertising content, software content, and/or any other content or data objects in electronic form. Features or attributes of content 122 may include but are not limited to popularity, topicality, trend, statistical change, most-talked or most-discussed about, critics ratings, viewers ratings, length/duration, demographic-specific popularity, segment-specific popularity, region-specific popularity, cost associated with a content item, revenue associated with a content item, subscription associated with a content item, and amount of advertising, for example.

In accordance with features of embodiments described herein, items of content 122 include subtitles comprising captions or text displayed at the bottom of a video portion of content that translate or transcribe the dialogue and/or narrative of the video portion.

In particular embodiments, metadata 124 may include data about content 122. For example, metadata 124 may include but is not limited to such information pertaining or relating to content 122 as plot line, synopsis, director, list of actors, list of artists, list of athletes/teams, list of writers, list of characters, length of content item, language of content item, country of origin of content item, genre, category, tags, presence of advertising content, viewers' ratings, critic's ratings, parental ratings, production company, release date, release year, platform on which the content item is released, whether it is part of a franchise or series, type of content item, sports scores, viewership, popularity score, minority group diversity rating, audio channel information, availability of subtitles, beats per minute, list of filming locations, list of awards, list of award nominations, seasonality information, scene and video understanding, and emotional understanding of the scene based on visual and dialogue cues, for example. Metadata 124 may additionally or alternatively include links to any such information pertaining to or relating to content 122. Metadata 124 may additionally or alternatively include one or more indices of content 122.

Multimedia environment 102 may include one or more system servers 126, which operate to support media devices 106 from the cloud. In particular embodiments, structural and functional aspects of system servers 126 may wholly or partially exist in the same or different ones of system servers 126.

Media devices, such as media device 106, may exist in numerous media systems, such as media system 104. Accordingly, media devices 106 may lend themselves to crowd sourcing embodiments and system servers 126 may include one or more crowdsource servers 128. System servers 126 may also include an audio command processing module 130 and a content segmentation module 132. As noted above, remote control device 116 may include a microphone 118, which may receive audio data from user 105 as well as from other sources, such as display device 108. In some embodiments, media device 106 may be audio responsive and the audio data may represent verbal commands from user 105 to control media device 106 as well as other components in media system 104, such as display device 108.

In some embodiments audio data received by microphone 118 is transferred to media device 106, which is then forwarded to audio command processing module 130. The audio command processing module 130 may operate to process and analyze the received audio data to recognize a verbal command from user 105. Audio command processing module 130 may then forward the verbal command to media device 106 for processing. In some embodiments, audio data may be additionally or alternatively processed and analyzed by an audio command processing module in media device 106 and system servers 126 may cooperate to select one of the verbal commands to process.

In accordance with features of particular embodiments, and as will be described in greater detail below, content segmentation module 132 supports deep video processing of content for dividing such content into segments based on content characteristics to facilitate content navigation, deep searching, generation of short video clips, or “shorts,” from longer video content, thematic clustering of segments, genre proportion analysis, and creation/identification of ad breaks, among others.

### Example Media Device

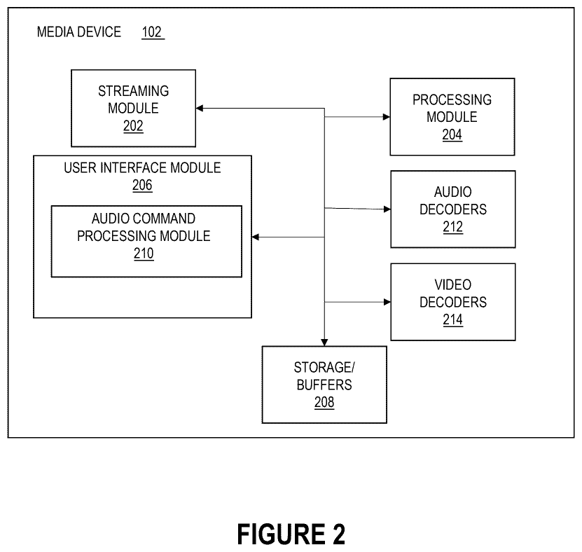

FIG. 2 illustrates a block diagram of an example media device 106 according to some embodiments. Media device 106 may include a streaming module 202, processing module 204, a user interface module 206, and storage/buffers 208. In particular embodiments, user interface module 206 may include an audio command processing module 210.

As shown in FIG. 2, media device 106 may also include one or more audio decoders 212 and one or more video decoders 214. Each audio decoder 212 may be configured to decode one or more audio formats, including but not limited to AAC, HE-AAC, AD3 (Dolby Digital), EAC3 (Dolby Digital Plus), WMA, WAV, PCM, MP3, OGG GSM, FLAC, AU, AIFF, and/or VOX, for example. Similarly, each video decoder 214 may be configured to decode video of one or more video formats, including but not limited to MP4 (e.g., mp4, m4a, m4v, f4v, f4a, m4b, m4r, f4b, mov), 3GP (e.g., 3gp, 3gp2, 3g2, 3gpp, 3gpp2), OGG (e.g., ogg, oga, ogv, ogx), WMV (e.g., wmv, wma, asf), WEBM, FLV, AVI, QuickTime, HDV, MXF, MPEG-TS, MPEG-2 PS, MPEG-2 TS, WAV, Broadcast WAV, LXF, GXF, and/or VOB, for example. Each video decoder 214 may include one or more video codecs, such as H.263, H.264, H.265, HEV, MPEG1, MPEG2, MPEG-TS, MPEG-4, Theora, 3GP, DV, DVCPRO, DVCProHD, IMX, XDCAM HD, XDCAM HD422, AND XDCAM EX, for example.

Referring now to both FIGS. 1 and 2, in some embodiments, user 105 may interact with media device 106 via, for example, remote control device 116. For example, user 105 may use remote control device 116 to interact with user interface module 206 of the media device 106 to select content, such as a movie, TV show, music, book, application, game, etc. The streaming module 202 of media device 106 may request the selected content from content servers 120 over network 110. Content servers 120 may transmit the requested content to streaming module 202. Media device 106 may transmit the received content to display device 108 for playback to user 105.

In streaming embodiments, streaming module 202 may transmit content to display device 108 in real time or near real time as it receives such content from content servers 120. In non-streaming embodiments, media device 106 may store content received from content servers 120 in storage/buffers 208 for later playback on display device 108, for example.

### Example Properties of Media Segments

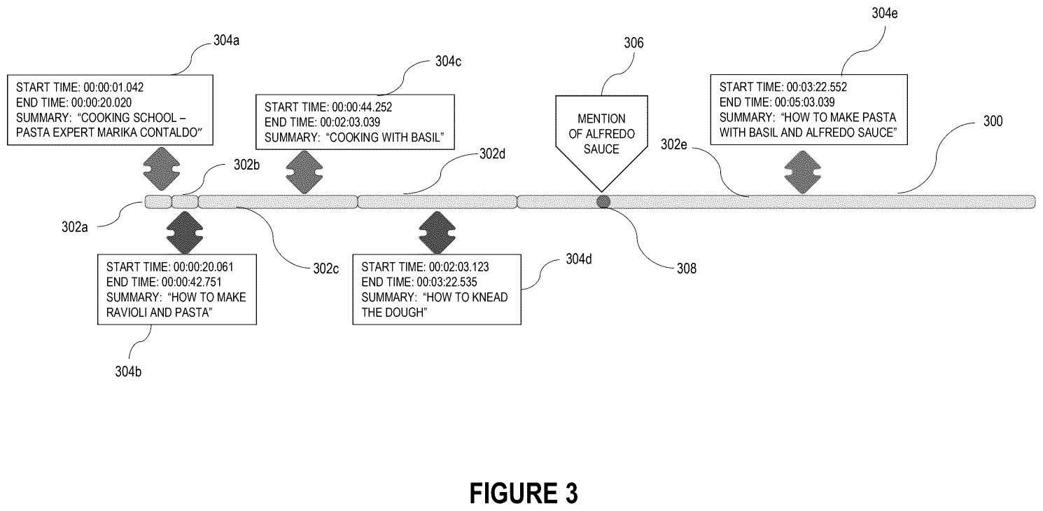

FIG. 3 illustrates the concept of segmentation of media content according to some embodiments of the disclosure. As shown in FIG. 3, media content 300 may be divided into smaller segments 302a-302e in accordance with techniques that will be described in greater detail below. Each of the segments 302a-302e has characteristics 304a-304e, including a Start Time, an End Time, and a Summary. For example, characteristics 304a of segment 302a include a Start Time of 00:00:01.042, an End Time of 00:00:20.020, and a Summary of “Cooking School-Pasta Expert Marika Contaldo.” Additionally a mention 306 of the phrase “alfredo sauce” is noted at a point 308 within content 300.

In accordance with features of embodiments described herein, a variety of types of segmentation may be performed. Sentence-level segmentation refers to the division of content based on spoken language (as indicated by subtitles or captions) or textual information. In this context, a video is divided into segments at points where sentences or spoken phrases change. Sentence-level segmentation is particularly useful for context indexing, transcription, and/or translation. For example, in a video transcript, each sentence or spoken phrase may be treated as a separate segment to improve searchability and navigation. In summary, sentence-level segmentation focuses on linguistic cues like spoken sentences. Concept-, or topic-, level segmentation involves dividing a video into segments based on the underlying concepts or topics covered in the content. Rather than relying solely or primarily on linguistic cues (as in sentence-level segmentation), concept-level segmentation takes into account broader themes or ideas presented in the content. For example, content comprising an educational video could be segmented based on distinct subject areas or lessons.

In particular embodiments, concept-segmentation may be performed on captions (or subtitles) for content. Captions data for an example item of content is provided in TABLE 1 below:

TABLE 1

| START TIME | END TIME | SUMMARY |
|---|---|---|
| 00:00:00.867 | 00:00:02.435 | Welcome to “Martha Cooks.” |
| 00:00:02.435 | 00:00:04.738 | With its endless versatility |
| 00:00:04.738 | 00:00:08.575 | and a little hint of nostalgia and |
| | | affordability, |
| 00:00:08.575 | 00:00:11.644 | chicken makes for one of the |
| | | most delicious dinners |
| 00:00:11.644 | 00:00:14.014 | a real family friendly favorite. |
| 00:00:14.014 | 00:00:18.184 | and today I'm going to be making |
| | | an elevated classic dinner |
| 00:00:18.184 | 00:00:20.720 | with a fresh, leafy green salad |
| 00:00:20.720 | 00:00:23.556 | and a delicious vinaigrette |
| | | that's light and bright. |

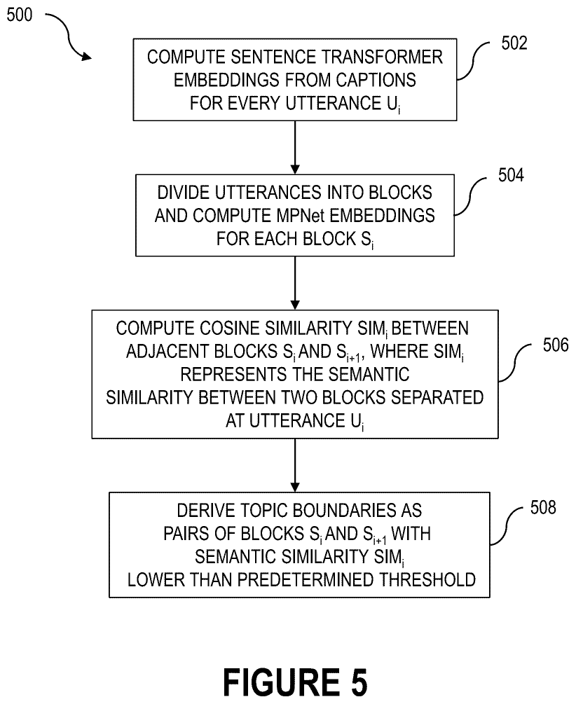

The input to a concept- (or topic-) level segmentation task are captions comprising a list of M utterances U={U₁, . . . , U_{M}} with an underlying topic structure represented by a reference topic segmentation T={T₁, . . . , T_{N}} with each topic having a start and an end utterance Tᵢ[Uⱼ, Uₖ]. The output of the task is a label sequence Y={y₁, . . . , y_{M}}, where yᵢ is a binary value that indicates whether the utterance Uᵢ is the start of a new topic segment. TextTiling may be used to detect topic changes with a similarity score based on word frequencies. Unsupervised topic segmentation of meetings with MPNet embeddings may be performed to detect topic changes based on a new similarity score using MPNet embeddings as described in detail below with reference to FIG. 5. Different thresholds can give different results of segments lengths.

A shot detection task may detect the boundaries between video shots by detecting a change in the visual scenes. Shots may be aligned with blocks of sentences to create shorts.

### Example Architecture for Generation of Segments from Larger Content

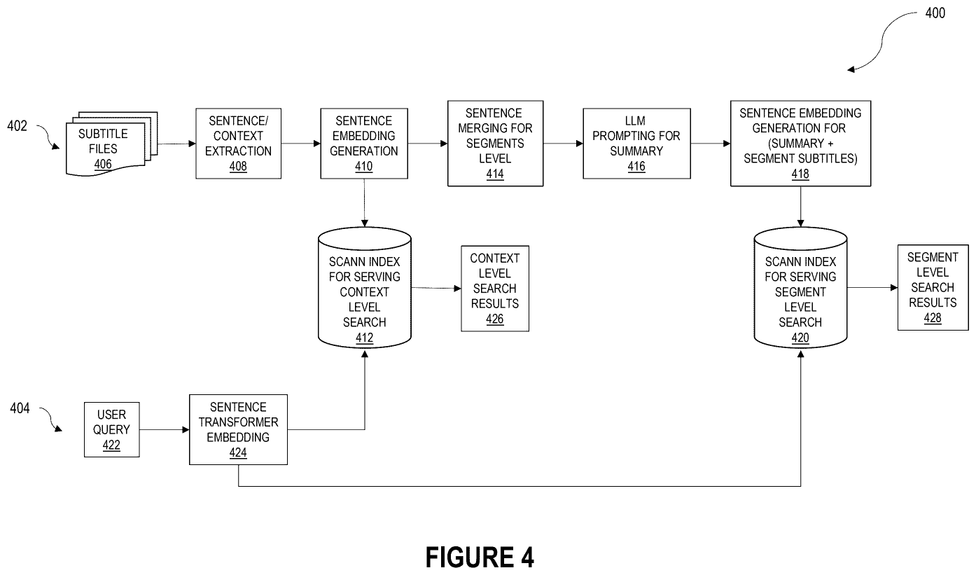

FIG. 4 illustrates a high-level block diagram of an example architecture of a system 400 for generating media segments from larger media content according to some embodiments of the disclosure. System 400 includes an offline portion 402 and an online portion 404. In the illustrated embodiment, subtitle files 406 are input to a sentence/context extraction module 408, the output of which is provided to a sentence embedding generation module 410. Sentence embeddings output from module 410 are input to a Scalable Nearest Neighbors (ScaNN) index for context level searching 412. Sentence embeddings output from module 410 are also provided to a sentence merging for segments level module 414, which performs tasks for merging sentences into segments. The merged sentences from module 414 are input to a large language model (LLM) prompting for summary module 416 which generates summaries of segments provided thereto. The output of module 416 is input to a sentence embedding generation for summary+segment subtitles module 418, the output of which is input to a ScaNN for serving segment level search 420.

In online portion 404, a user query 422 is input to a sentence transformer embedding module 424, the output of which is fed to ScaNN 412 and/or ScaNN 420 to generate context level search results 426 and/or segment level search results 428.

### Example Techniques for Generation of Segments from Larger Content

FIG. 5 is a flow diagram 500 of example operations performed in connection with techniques for generation of segments from larger content such as content 122 (FIG. 5), for enabling intelligent navigation of media content and other features according to some embodiments of the disclosure. In certain embodiments, one or more of the operations illustrated in FIG. 5 shown in FIGS. 1, 2, and/or 3, for example.

In operation 502, sentence transformer embeddings are computed for each of M utterances Uᵢ={U₁, . . . , U_{M}} from the captions.

In operation 504, the utterances are divided into blocks (e.g., sentences {Sᵢ, . . . , Sₖ} and a blockwise operation is performed to extract the embedding Sᵢ for each block.

In operation 506, the cosine similarity sim; between adjacent blocks Sᵢ and Sᵢ₊₁, where sim; represents the semantic similarity between two blocks separated at utterance Uᵢ.

In operation 508, the topic boundaries as pairs of blocks Sᵢ and Sᵢ₊₁ with semantic similarity simᵢ lower than a certain threshold are derived. It will be noted that different thresholds can provide different segment length results. It will be recognized that use of a small threshold (resulting in creation of more, smaller segments for an item of content) may make the resultant searches more precise and cause the user to have to consume less content in response to their search; however, use of a larger threshold (resulting in creation of fewer, larger segments for an item of content), may have other advantages. In particular embodiments, multiple different thresholds may be applied in order to create segments of different length for a single item of content.

Although the operations of the example method shown in and described with reference to FIG. 5 are illustrated as occurring once each and in a particular order, it will be recognized that the operations may be performed in any suitable order and repeated as desired. Additionally, one or more operations may be performed in parallel. Furthermore, the operations illustrated in FIG. 5 may be combined or may include more or fewer details than described.

Embodiments described herein may find application in a variety of areas. For example, dividing video content into segments facilitates direct searching and navigation within the content, thus minimizing the need for the user to watch the entire video content and enabling quick access to the desired information. Additionally, it enables users to search for specific terms or phrases and to be directed to the exact segment of the video where those terms/phrases appear. Additionally, users can easily switch to the next mention of the terms/phrases or the next segment containing the terms/phrases. Embodiments may enable users to search content for characters or plots, to generate AutoPlay videos, and to generate more artwork for the content.

Embodiments described herein may also streamline content exploration, especially for original content. In particular, video segmentation such as described herein aids in better content organization and discovery. By dividing videos into segments, users can more easily find specific topics or moments within a video, making int convention to search for and jump to relevant parts of the content, thus enhancing user satisfaction and encouraging user interaction with the content. Embodiments may provide an enhanced user experience; in particular, breaking longer content into shorter segments can improve a user's engagement and retention of information contained in the content. Additionally, shorter segments are more easily consumed and may align with users' shorter attention spans.

Still further, embodiments described herein may provide engagement metrics and analysis. By tracking user interactions with specific segments, content creators and platforms can gain insight into which parts of a particular item of content are most popular, where users drop off, and which content resonates most with users, for example. Moreover, content segmentation provides opportunities for targeted ad insertion and thus additional monetization of content. In particular, advertisers may choose to insert ads before, during, or after particular segments, aligning their ads with topically related content if they choose to do so. Embodiments described herein may further enable cluster creation for thematic content as similar video segments can be grouped together based on topics or themes, making it easier for users to find related content. Short segments may be repurposed for different platforms and purposes, thus enhancing content reusability and distribution, with specific segments being sharable on social media, promotional material, or as teasers to attract users to the full content. Embodiments may also support personalization and recommendation. In particular, through understanding user preferences and interactions with specific segments, recommendation algorithms can suggest relevant content to individual users more accurately.

### Example Processing Device

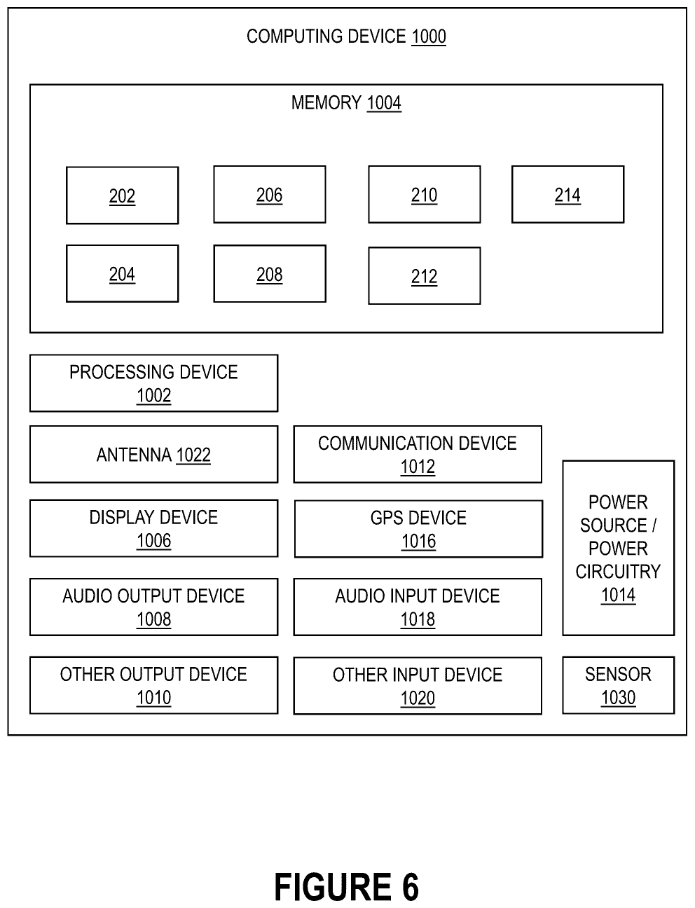

FIG. 6 is a block diagram of an example processing, or computing, device 1000, according to some embodiments of the disclosure. One or more computing devices, such as computing device 1000, may be used to implement the functionalities described with reference to the FIGURES and herein. A number of components are illustrated in the FIGURES as included in the computing device 1000, but any one or more of these components may be omitted or duplicated, as suitable for the application. In some embodiments, some or all of the components included in the computing device 1000 may be attached to one or more motherboards. In some embodiments, some or all of these components are fabricated onto a single system on a chip (SoC) die. Additionally, in various embodiments, the computing device 1000 may not include one or more of the components illustrated in FIG. 6, and the computing device 1000 may include interface circuitry for coupling to the one or more components. For example, the computing device 1000 may not include a display device 1006, and may include display device interface circuitry (e.g., a connector and driver circuitry) to which a display device 1006 may be coupled. In another set of examples, the computing device 1000 may not include an audio input device 1018 or an audio output device 1008 and may include audio input or output device interface circuitry (e.g., connectors and supporting circuitry) to which an audio input device 1018 or audio output device 1008 may be coupled.

The computing device 1000 may include a processing device 1002 (e.g., one or more processing devices, one or more of the same type of processing device, one or more of different types of processing device). The processing device 1002 may include electronic circuitry that process electronic data from data storage elements (e.g., registers, memory, resistors, capacitors, quantum bit cells) to transform that electronic data into other electronic data that may be stored in registers and/or memory. Examples of processing device 1002 may include a central processing unit (CPU), a graphical processing unit (GPU), a quantum processor, a machine learning processor, an artificial-intelligence processor, a neural network processor, an artificial intelligence accelerator, an application specific integrated circuit (ASIC), an analog signal processor, an analog computer, a microprocessor, a digital signal processor.

The computing device 1000 may include a memory 1004, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 1004 includes one or more non-transitory computer-readable storage media. In some embodiments, memory 1004 may include memory that shares a die with the processing device 1002. In some embodiments, memory 1004 includes one or more non-transitory computer-readable media storing instructions executable to perform operations described with the FIGURES and herein, such as the methods illustrated in FIGS. 3-6. Exemplary parts or modules that may be encoded as instructions and stored in memory 1004 are depicted. Memory 1004 may store instructions that encode one or more exemplary parts. The instructions stored in the one or more non-transitory computer-readable media may be executed by processing device 1002. In some embodiments, memory 1004 may store data, e.g., data structures, binary data, bits, metadata, files, blobs, etc., as described with the FIGURES and herein. Exemplary data that may be stored in memory 1004 are depicted. Memory 1004 may store one or more data as depicted.

In some embodiments, the computing device 1000 may include a communication device 1012 (e.g., one or more communication devices). For example, the communication device 1012 may be configured for managing wired and/or wireless communications for the transfer of data to and from the computing device 1000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 1012 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 1012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 1012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 1012 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 1012 may operate in accordance with other wireless protocols in other embodiments. The computing device 1000 may include an antenna 1022 to facilitate wireless communications and/or to receive other wireless communications (such as radio frequency transmissions). The computing device 1000 may include receiver circuits and/or transmitter circuits. In some embodiments, the communication device 1012 may manage wired communications, such as electrical, optical, or any other suitable communication protocols (e.g., the Ethernet). As noted above, the communication device 1012 may include multiple communication chips. For instance, a first communication device 1012 may be dedicated to shorter-range wireless communications such as Wi-Fi or Bluetooth, and a second communication device 1012 may be dedicated to longer-range wireless communications such as global positioning system (GPS), EDGE, GPRS, CDMA, WiMAX, LTE, EV-DO, or others. In some embodiments, a first communication device 1012 may be dedicated to wireless communications, and a second communication device 1012 may be dedicated to wired communications.

The computing device 1000 may include power source/power circuitry 1014. The power source/power circuitry 1014 may include one or more energy storage devices (e.g., batteries or capacitors) and/or circuitry for coupling components of the computing device 1000 to an energy source separate from the computing device 1000 (e.g., DC power, AC power, etc.).

The computing device 1000 may include a display device 1006 (or corresponding interface circuitry, as discussed above). The display device 1006 may include any visual indicators, such as a heads-up display, a computer monitor, a projector, a touchscreen display, a liquid crystal display (LCD), a light-emitting diode display, or a flat panel display, for example.

The computing device 1000 may include an audio output device 1008 (or corresponding interface circuitry, as discussed above). The audio output device 1008 may include any device that generates an audible indicator, such as speakers, headsets, or earbuds, for example.

The computing device 1000 may include an audio input device 1018 (or corresponding interface circuitry, as discussed above). The audio input device 1018 may include any device that generates a signal representative of a sound, such as microphones, microphone arrays, or digital instruments (e.g., instruments having a musical instrument digital interface (MIDI) output).

The computing device 1000 may include a GPS device 1016 (or corresponding interface circuitry, as discussed above). The GPS device 1016 may be in communication with a satellite-based system and may receive a location of the computing device 1000, as known in the art.

The computing device 1000 may include a sensor 1030 (or one or more sensors). The computing device 1000 may include corresponding interface circuitry, as discussed above). Sensor 1030 may sense physical phenomenon and translate the physical phenomenon into electrical signals that can be processed by, e.g., processing device 1002. Examples of sensor 1030 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 1000 may include another output device 1010 (or corresponding interface circuitry, as discussed above). Examples of the other output device 1010 may include an audio codec, a video codec, a printer, a wired or wireless transmitter for providing information to other devices, haptic output device, gas output device, vibrational output device, lighting output device, home automation controller, or an additional storage device.

The computing device 1000 may include another input device 1020 (or corresponding interface circuitry, as discussed above). Examples of the other input device 1020 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1000 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some embodiments, the computing device 1000 may be any other electronic device that processes data.

### Selected Examples

Example 1 provides a method including obtaining subtitles for an item of media content; dividing the subtitles into topics to create shorts corresponding to the topics; obtaining video data for the item of media content; dividing the video data into video shots, in which the dividing occurs at scene boundaries of the video data; and aligning the shorts with the video shots to create content segments.

Example 2 provides the method of example 1, in which the aligning the shorts with the video shots to create content segments further includes comparing an end time of one of the shorts with an end time of an aligned one of the video shots.

Example 3 provides the method of example 2, in which the aligning the shorts with the video shots to create content segments further includes updating the end time of the aligned one of the video shots to correspond to the end time of the short.

Example 4 provides the method of any one of examples 1-3, in which the content segments are searchable.

Example 5 provides the method of any one of examples 1-4, in which each of the content segments has associated therewith a start time, an end time, and a summary.

Example 6 provides the method of any one of examples 1-5, further including identifying content segments that correspond to a search request from a user and displaying a thumbnail for each of the identified content segments.

Example 7 provides the method of any one of examples 1-6, during presentation of the content to a user, navigating directly to an adjacent segment in response to a corresponding navigational command.

Example 8 provides a multimedia system, including a processor; a memory device; a database including items of media content, in which each of the items of media content has metadata associated therewith; and a content processing module configured to: divide the items of media content into segments; receive a search query in connection with the items of media content; present search results including ones of the segments of the items of media content that correspond to the search query; and in response to selection of one of the segments from the search results, navigate a presentation to a beginning of the selected one of the segments.

Example 9 provides the multimedia system of example 8, in which the selected one of the segments corresponds to a word or phrase.

Example 10 provides the multimedia system of example 8 or 9, in which the selected one of the segments corresponds to a sentence.

Example 11 provides the multimedia system of any one of examples 8-10, in which the selected one of the segments corresponds to a group of related sentences including a topic.

Example 12 provides the multimedia system of example 11, in which the selected one of the segments has associated therewith a start time, an end time, and a summary of the topic.

Example 13 provides the multimedia system of example 12, in which the start time and the end time are measured from a start time of a corresponding one of the items of media content.

Example 14 provides the multimedia system of any one of examples 8-13, in which the presenting further includes, for each of the ones of the segments of the items of media content that correspond to the search query, displaying a thumbnail corresponding to the segment.

Example 15 provides the multimedia system of example 14, in which each of the thumbnails includes an image derived from video data including the corresponding segment.

Example 16 provides one or more non-transitory computer-readable storage media including instructions for execution which, when executed by a processor, result in operations including generating a list of utterances from captions corresponding to an item of media content; dividing the utterances into sentences; computing a semantic similarity between a first set of adjacent sentences; and if the semantic similarity between the first set of adjacent sentences has a first relationship to a predetermined threshold, merging the first set of adjacent sentences into a block.

Example 17 provides the one or more non-transitory computer-readable storage media of example 16, in which the operations further include, for each of the sentences, extracting a sentence transformer embedding for the sentences, in which the computing a semantic similarity between the first set of adjacent sentences is performed using the sentence transformer embeddings for the first set of adjacent sentences.

Example 18 provides the one or more non-transitory computer-readable storage media of example 16 or 17, in which the operations further include if the semantic similarity between the first set of adjacent sentences has a second relationship to the predetermined threshold, imposing a topic boundary between the first set of adjacent sentences.

Example 19 provides the one or more non-transitory computer-readable storage media of any one of examples 16-18, in which the operations further include computing a semantic similarity between a last sentence including the block and one of the sentences adjacent to the block; and if the semantic similarity between the block and the one of the sentences adjacent to the block has the first relationship to the predetermined threshold, merging the one of the sentences adjacent to the block with the block.

Example 20 provides the one or more non-transitory computer-readable storage media of any one of examples 16-19, in which the block includes a media segment having associated therewith a start time, an end time, and a summary of contents of the block.

### Variations and Other Notes

The above paragraphs provide various examples of the embodiments disclosed herein.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials, and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the above detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the above detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/-5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. A method comprising:
obtaining subtitles for an item of media content;
dividing the subtitles into topics to create shorts corresponding to the topics;
obtaining video data for the item of media content;
dividing the video data into video shots, wherein the dividing occurs at scene boundaries of the video data; and
aligning the shorts with the video shots to create content segments.

2. The method of claim 1, wherein the aligning the shorts with the video shots to create content segments further comprises comparing an end time of one of the shorts with an end time of an aligned one of the video shots.

3. The method of claim 2, wherein the aligning the shorts with the video shots to create content segments further comprises updating the end time of the aligned one of the video shots to correspond to the end time of the short.

4. The method of claim 1, wherein the content segments are searchable.

5. The method of claim 1, wherein each of the content segments has associated therewith a start time, an end time, and a summary.

6. The method of claim 1, further comprising identifying content segments that correspond to a search request from a user and displaying a thumbnail for each of the identified content segments.

7. The method of claim 1, during presentation of the content to a user, navigating directly to an adjacent segment in response to a corresponding navigational command.

8. A multimedia system, comprising:
a processor;
a memory device;
a database comprising items of media content, wherein each of the items of media content has metadata associated therewith; and
a content processing module configured to:
divide the items of media content into segments;
receive a search query in connection with the items of media content;
present search results comprising ones of the segments of the items of media content that correspond to the search query; and
in response to selection of one of the segments from the search results, navigate a presentation to a beginning of the selected one of the segments.

9. The multimedia system of claim 8, wherein the selected one of the segments corresponds to a word or phrase.

10. The multimedia system of claim 8, wherein the selected one of the segments corresponds to a sentence.

11. The multimedia system of claim 8, wherein the selected one of the segments corresponds to a group of related sentences comprising a topic.

12. The multimedia system of claim 11, wherein the selected one of the segments has associated therewith a start time, an end time, and a summary of the topic.

13. The multimedia system of claim 12, wherein the start time and the end time are measured from a start time of a corresponding one of the items of media content.

14. The multimedia system of claim 8, wherein the presenting further comprises, for each of the ones of the segments of the items of media content that correspond to the search query, displaying a thumbnail corresponding to the segment.

15. The multimedia system of claim 14, wherein each of the thumbnails comprises an image derived from video data comprising the corresponding segment.

16. One or more non-transitory computer-readable storage media comprising instructions for execution which, when executed by a processor, result in operations comprising:
generating a list of utterances from captions corresponding to an item of media content;
dividing the utterances into sentences;
computing a semantic similarity between a first set of adjacent sentences; and
if the semantic similarity between the first set of adjacent sentences has a first relationship to a predetermined threshold, merging the first set of adjacent sentences into a block.

17. The one or more non-transitory computer-readable storage media of claim 16, wherein the operations further comprise, for each of the sentences, extracting a sentence transformer embedding for the sentences, wherein the computing a semantic similarity between the first set of adjacent sentences is performed using the sentence transformer embeddings for the first set of adjacent sentences.

18. The one or more non-transitory computer-readable storage media of claim 16, wherein the operations further comprise:
if the semantic similarity between the first set of adjacent sentences has a second relationship to the predetermined threshold, imposing a topic boundary between the first set of adjacent sentences.

19. The one or more non-transitory computer-readable storage media of claim 16, wherein the operations further comprise:
computing a semantic similarity between a last sentence comprising the block and one of the sentences adjacent to the block; and
if the semantic similarity between the block and the one of the sentences adjacent to the block has the first relationship to the predetermined threshold, merging the one of the sentences adjacent to the block with the block.

20. The one or more non-transitory computer-readable storage media of claim 16, wherein the block comprises a media segment having associated therewith a start time, an end time, and a summary of contents of the block.
